(19) United States
(12) Patent Application Publication
(10) Pub. No.: US 2017/0286471 A1
(43) Pub. Date: Oct. 5, 2017

(54) METHODS AND APPARATUSES FOR ENTERPRISE REVISION-BASED AUDITING OF DATABASE MANAGEMENT SYSTEMS

(71) Applicant: McKesson Corporation, San Francisco, CA (US)

(72) Inventor: Shridhar Upadhyaya, Fremont, CA (US)

(21) Appl. No.: 15/087,081

(22) Filed: Mar. 31, 2016

(51) Int. Cl. G06F 17/30

(52) U.S. Cl. CPC G06F 17/30356; G06F 17/30377; G06F 17/30368; G06F 17/30365; G06F 17/30457; G06F 17/30563

(57) ABSTRACT

Embodiments are disclosed for improving scalability and efficiency of an online transaction processing (OLTP) system. In the context of a method, an example embodiment includes assigning, by revisioning circuitry and in response to receiving a change data instruction to edit one or more data tables stored by the OLTP system, a global revision number to the change data instruction, wherein the global revision number is unique within the OLTP system, and updating, by data modeling circuitry, one or more records in the one or more data tables stored by the OLTP system based on the change data instruction. The example method further includes inserting, by data auditing circuitry, one or more audit records corresponding to the one or more updated records into one or more audit tables corresponding to the one or more data tables. Corresponding apparatuses and computer program products are also provided.

### TECHNOLOGICAL FIELD

Example embodiments of the present invention relate generally to database management system administration and, more particularly, to methods and apparatuses for improving scalability and efficiency of database management systems.

### BACKGROUND

In many commercial database management systems operating in an online transaction processing (OLTP) environment, there is a need to store audit tables cataloguing changes made by various users to corresponding data tables (which may, in turn, store sensitive information regarding customers, patients, service providers, or the like). In many examples, such audit table utilization is needed to fulfill certification requirements that include capturing both what user is making a change (and on whose behalf that user is acting, if acting in a representative capacity) and what change that user is making (e.g., adding, modifying, or deleting a record), along with a timestamp indicating when the change takes place.

Current methods for addressing audit tables do not scale well, nor do they perform well when used in an OLTP environment. Instead, these current methods execute an excessive number of structured query language (SQL) statements, leading to poor performance. Moreover, legacy solutions relying on the use of database triggers also present significant maintenance problems, because as the scale of the system increases, policing the proper utilization of database triggers becomes increasingly difficult.

### BRIEF SUMMARY

Example embodiments described herein address at least the above deficiencies and provide methods and apparatuses that utilize enterprise-level revision numbering to readily identify changes associated with a given revision, and subsequently utilize pre-generated and cached insert statements to greatly reduce the number of SQL statements required to commit such changes to the data tables and corresponding audit tables in an OLTP system. In this fashion, example embodiments thereby improve the efficiency and scalability of database management systems.

In a first example embodiment, a method is provided for improving scalability and efficiency of an online transaction processing (OLTP) system. The method includes assigning, by revisioning circuitry and in response to receiving a change data instruction to edit one or more data tables stored by the OLTP system, a global revision number to the change data instruction, wherein the global revision number is unique within the OLTP system. The method further includes updating, by data modeling circuitry, one or more records in the one or more data tables stored by the OLTP system based on the change data instruction, and inserting, by data auditing circuitry, one or more audit records corresponding to the one or more updated records into one or more audit tables corresponding to the one or more data tables. It should be understood that each audit record includes a revision number field identifying the global revision number and a revision type field indicating whether a corresponding updated record of the one or more updated records is newly added, modified from a previous version, or deleted.

In some embodiments, assigning the global revision number to the revision includes generating the global revision number, and storing the global revision number in a global revision tracking table.

In some embodiments, inserting the one or more audit records corresponding to the one or more updated records into the one or more audit tables corresponding to the one or more tables includes generating insert statements for the one or more audit tables, and, for each particular audit table corresponding to a particular data table of the one or more data tables, invoking the insert statement generated for the particular audit table to add a subset of the one or more audit records into the particular audit table that correspond to a subset of the updated records that are stored in the particular data table. In some such embodiments, generating the insert statements includes analyzing metadata of the one or more data tables, building insert statements for the one or more audit tables based on the metadata of each corresponding data table, and caching the insert statements. Additionally or alternatively, invoking the insert statement generated for a particular audit table includes binding, to the insert statement generated for the particular audit table, row data in the particular data table that describes the subset of the updated records that are stored in the particular data table, and causing execution of the insert statement generated for the particular audit table. Furthermore, inserting the one or more audit records into the one or more audit tables may include invoking insert statements corresponding to multiple audit tables in a batch process.

In some embodiments, the change data instruction is received from a Java 2 Platform, Enterprise Edition (J2EE) application using a Java database connectivity (JDBC) driver, or from a data warehouse extract, transform, and load (ETL) process.

In a second example embodiment, an apparatus is provided for improving scalability and efficiency of an online transaction processing (OLTP) system. The apparatus includes at least one processor and at least one memory storing computer-executable instructions, that, when executed by the at least one processor, cause the apparatus to assign, in response to receiving a change data instruction to edit one or more data tables stored by the OLTP system, a global revision number to the change data instruction, wherein the global revision number is unique within the OLTP system. The computer-executable instructions, when executed by the at least one processor, further cause the apparatus to update one or more records in the one or more data tables stored by the OLTP system based on the change data instruction, and insert one or more audit records corresponding to the one or more updated records into one or more audit tables corresponding to the one or more data tables. It should be understood that each audit record includes a revision number field identifying the global revision number and a revision type field indicating whether a corresponding updated record of the one or more updated records is newly added, modified from a previous version, or deleted.

In some embodiments, the computer-executable instructions, when executed by the at least one processor, cause the apparatus to assign the global revision number to the revision by causing the apparatus to generate the global revision number, and store the global revision number in a global revision tracking table.

In some embodiments, the computer-executable instructions, when executed by the at least one processor, cause the apparatus to insert the one or more audit records corresponding to the one or more updated records into the one or more audit tables corresponding to the one or more tables includes by causing the apparatus to generate insert statements for the one or more audit tables, and, for each particular audit table corresponding to a particular data table of the one or more data tables, invoke the insert statement generated for the particular audit table to add a subset of the one or more audit records into the particular audit table that correspond to a subset of the updated records that are stored in the particular data table. In some such embodiments, the computer-executable instructions, when executed by the at least one processor, cause the apparatus to generate the insert statements by causing the apparatus to analyze metadata of the one or more data tables, build insert statements for the one or more audit tables based on the metadata of each corresponding data table, and cache the insert statements. Additionally or alternatively, the computer-executable instructions, when executed by the at least one processor, cause the apparatus to invoke the insert statement generated for a particular audit table by causing the apparatus to bind, to the insert statement generated for the particular audit table, row data in the particular data table that describes the subset of the updated records that are stored in the particular data table, and cause execution of the insert statement generated for the particular audit table. Furthermore, the computer-executable instructions, when executed by the at least one processor, cause the apparatus to insert the one or more audit records into the one or more audit tables by causing the apparatus to invoke insert statements corresponding to multiple audit tables in a batch process.

In some embodiments, the change data instruction is received from a Java 2 Platform, Enterprise Edition (J2EE) application using a Java database connectivity (JDBC) driver, or from a data warehouse extract, transform, and load (ETL) process.

In a third example embodiment, a computer program product comprising at least one non-transitory computer-readable storage medium is provided for improving scalability and efficiency of an online transaction processing (OLTP) system. The at least one non-transitory computer readable storage medium stores computer-executable instructions that, when executed, cause an apparatus to assign, in response to receiving a change data instruction to edit one or more data tables stored by the OLTP system, a global revision number to the change data instruction, wherein the global revision number is unique within the OLTP system. The computer-executable instructions, when executed, further cause the apparatus to update one or more records in the one or more data tables stored by the OLTP system based on the change data instruction, and insert one or more audit records corresponding to the one or more updated records into one or more audit tables corresponding to the one or more data tables. It should be understood that each audit record includes a revision number field identifying the global revision number and a revision type field indicating whether a corresponding updated record of the one or more updated records is newly added, modified from a previous version, or deleted.

In some embodiments, the computer-executable instructions, when executed, cause the apparatus to assign the global revision number to the revision by causing the apparatus to generate the global revision number, and store the global revision number in a global revision tracking table.

In some embodiments, the computer-executable instructions, when executed, cause the apparatus to insert the one or more audit records corresponding to the one or more updated records into the one or more audit tables corresponding to the one or more tables includes by causing the apparatus to generate insert statements for the one or more audit tables, and, for each particular audit table corresponding to a particular data table of the one or more data tables, invoke the insert statement generated for the particular audit table to add a subset of the one or more audit records into the particular audit table that correspond to a subset of the updated records that are stored in the particular data table. In some such embodiments, the computer-executable instructions, when executed, cause the apparatus to generate the insert statements by causing the apparatus to analyze metadata of the one or more data tables, build insert statements for the one or more audit tables based on the metadata of each corresponding data table, and cache the insert statements. Additionally or alternatively, the computer-executable instructions, when executed, cause the apparatus to invoke the insert statement generated for a particular audit table by causing the apparatus to bind, to the insert statement generated for the particular audit table, row data in the particular data table that describes the subset of the updated records that are stored in the particular data table, and cause execution of the insert statement generated for the particular audit table. Furthermore, the computer-executable instructions, when executed, cause the apparatus to insert the one or more audit records into the one or more audit tables by causing the apparatus to invoke insert statements corresponding to multiple audit tables in a batch process.

In some embodiments, the change data instruction is received from a Java 2 Platform, Enterprise Edition (J2EE) application using a Java database connectivity (JDBC) driver, or from a data warehouse extract, transform, and load (ETL) process.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings, which are not necessarily drawn to scale.

FIG. 1A illustrates an example computing system within which embodiments of the present invention may operate.

FIG. 1B illustrates an example database, in accordance with some example embodiments described herein.

FIG. 2A illustrates an example data table, in accordance with some example embodiments described herein.

FIG. 2B illustrates an example audit table corresponding to the data table of FIG. 2A, in accordance with some example embodiments described herein.

FIG. 2C illustrates an example global revision tracking table, in accordance with some example embodiments described herein.

FIG. 2D illustrates a second example data table, in accordance with some example embodiments.

FIG. 2E illustrates a second example audit table corresponding to the second example data table, in accordance with some example embodiments.

FIG. 3 illustrates a schematic block diagram of example circuitry embodying a device that may perform operations in accordance with some example embodiments described herein.

FIG. 4 illustrates a flowchart describing example operations for improving scalability and efficiency of an OLTP system, in accordance with some example embodiments described herein.

FIG. 5 illustrates a flowchart describing example operations for inserting one or more audit records corresponding to the one or more updated records into one or more audit tables corresponding to the one or more data tables, in accordance with some example embodiments described herein.

FIG. 6 illustrates a flowchart describing example operations for generating insert statements for one or more audit tables, in accordance with some example embodiments described herein.

FIG. 7 illustrates a flowchart describing example operations for invoking insert statements generated for one or more audit tables, in accordance with some example embodiments described herein.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention.

### Overview

Example methods and apparatuses disclosed herein improve the scalability and efficiency of database management systems. To do this, example embodiments utilize enterprise-level revision numbering to readily identify changes associated with a given revision, and utilize pre-generation and caching of SQL insert statements in a manner that greatly reduces the number of SQL statements required to commit changes to the audit tables corresponding to data tables in an OLTP system. Both practices signal a departure from traditional methods for database management.

Traditional systems use time stamping to identify when various transactions occur. However, time stamping may pose problems when there are parallel transactions that begin at the same instant. Specifically, because large database systems often utilize a distributed architecture and have many entities accessing and modifying data in parallel, it is possible that time stamps indicating when events occur may not accurately reflect the true sequence of changes to the data tables stored in the system. Accordingly, traditional systems are often unable to provide completely auditable records.

In contrast, embodiments contemplated herein model changes to the database as global transactions, and associate a single unique global revision number with every database change emanating from a single transaction. Accordingly, even in situations where parallel transactions begin at the same instant, these separate transactions will have their own global revision numbers. These global revision numbers can then be used to query the audit tables to find out changes done. As an example in the healthcare context, consider the situation in which a physician has diagnosed a patient with cancer. The physician may prescribe a course of treatment and enter that prescription into an OLTP system. The medication may consist of a regimen of three pills a day for 21 days. In this example, embodiments contemplated herein may contain a table for cataloging the regimen (e.g., a regimen table) and another table for cataloging the various orders that make up that regimen (e.g., an order table). In this example, while the regimen table may list only a single record (the prescribed regimen), the order table may list many more records (e.g., 63 records, representing three orders a day for 21 days). For auditing purposes, in addition to the regimen table and the order table the system will include corresponding peer tables (hereinafter, audit tables) tracking changes to each of the regimen table and the order table. These peer tables will be referred to with respect to this example as a regimen audit table and an order audit table.

Example embodiments contemplated herein utilize a global revision tracking table to assign a global revision number to the course of treatment, and the records stored in the regimen audit table and the order audit table will therefore also be associated with the global revision number. A system that implements the regimen management function will insert a record into the global revision table that includes a field that is then populated with a global revision number. This new global revision number will then be used to insert records in audit tables for any related tables in that transaction. These audit tables will also track a revision type associated with each database modification (e.g., the type of change being performed, such as add, modify, or delete). It should be appreciated that the records in these audit tables will also include the entirety of the information in each record of the corresponding regimen table and order table. Thus, in this example, because the physician has taken a single action, a single global revision number will be associated with the prescription. In turn, however, the regimen audit table will include a field associating the global revision number of the course of treatment with the single related record in the regimen audit table, and the record audit table will include a field associating the 62 order records in the order table with the same global revision number, as all of these records are logically related to the underlying transaction.

Enterprise revision numbering of this nature facilitates two separate ways to query the database. First, all changes emanating from a single transaction are associated with the same global revision number, and thus a query for that global revision number will return all of the database changes made as a result of the course of treatment. Second, all changes for a given row can be viewed across revisions based on the use of the records stored in the regimen audit table and the order audit table. Because the use of enterprise revision numbering facilitates queries for all changes associated with a given revision in addition to queries for changes for a given row across multiple revisions, the architecture described herein leads to very expressive SQL-based querying for generation of audit reports.

Another aspect of example embodiments described herein is that updating the audit tables can be streamlined given an understanding of the various changes that will be made to each audit table. For instance, in the example described above, 61 records will be added to the order table, and 61 corresponding records must be added to the order audit table. Traditional systems would update the audit table on a record-by-record basis, thus utilizing 61 separate SQL insert statements. However, because all of the 61 records are associated with a single global revision number, example embodiments described herein are able to streamline this process. Rather than performing 61 separate SQL statements, example embodiments may therefore generate a single insert statement, bind the 61 rows of data from the order table to that insert statement, and then execute the single insert statement to update the order audit table. Accordingly, the use of global revision numbers thereby facilitates efficiency-enhancements that would be unattainable for embodiments that are unable to determine the relationships between similar database modifications.

Thus, example embodiments provide methods and apparatuses that utilize enterprise revision numbering to readily identify changes associated with a given revision, and, as described in greater detail below, enable example systems to exploit greater efficiencies when subsequently committing such changes to the audit tables in an OLTP system. Further details regarding the implementing systems, methods, and apparatuses are described below.

### Example Implementing System and Data Structures

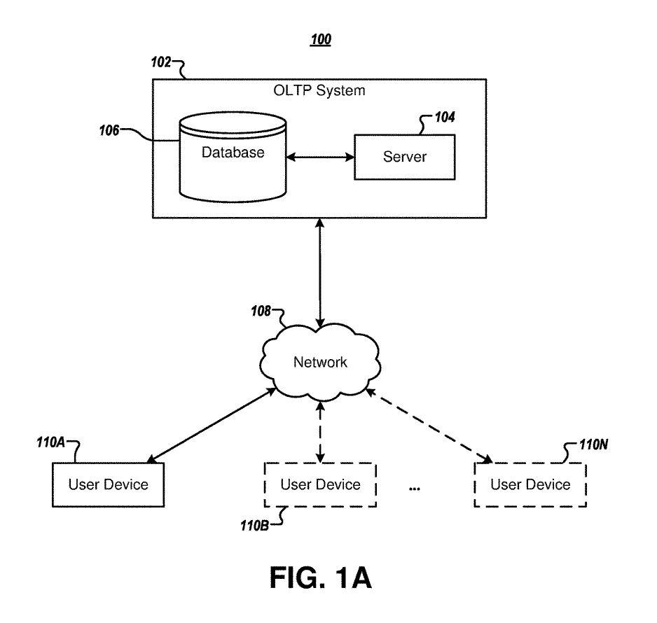

FIG. 1A discloses an example computing system to provide some context regarding the environment within which embodiments of the present invention may operate. Users may interact with an OLTP system 102 via a network 108 (e.g., the Internet, or the like) using user devices 110A through 110N. While it is expected that at least one user will interact with OLTP system 102 in example computing system 100, varying embodiments contemplate any number of users interacting with the OLTP system 102 via corresponding user terminals devices 110.

The OLTP system 102 may comprise a server 104 in communication with a database 106. The server 104 may be embodied as a computer or computers as known in the art. The server 104 may collect information from various sources, including but not necessarily limited to the user devices 110A through 110N. For example, the server 104 may be operable to receive and process change data instructions provided by either a user device 110 and/or by other devices. The server 104 may also facilitate updating of data tables stored in the database 106. The server 104 may also facilitate the generation and provision of various information to users in response to queries for information from the database 106.

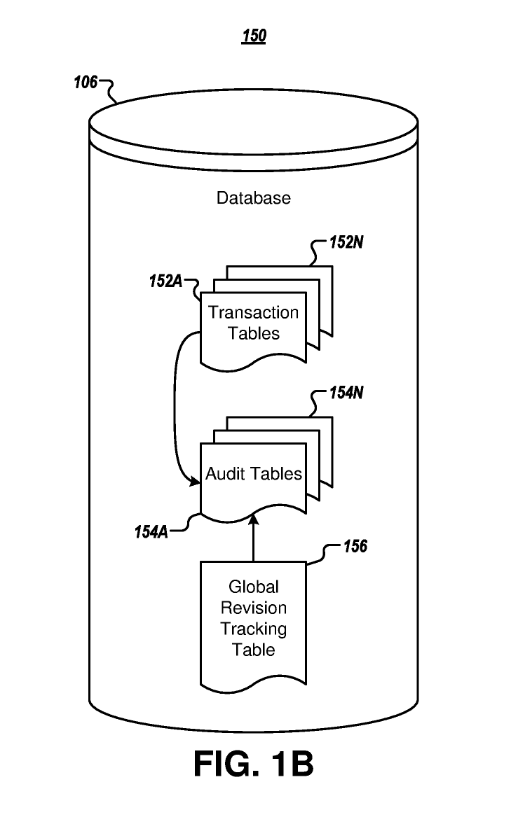

Turning now to FIG. 1B, the database 106 will be described in greater detail. The database 106 may be embodied as a data storage device such as a Network Attached Storage (NAS) device or devices, or as a separate database server or servers. The database 106 includes information accessed and stored by the server 104 to facilitate the operations of the OLTP system 102. For example, the database 106 may comprise a series of data tables 152A through 152N and may further include corresponding audit tables 154A through 154N. Each data table 152 may store information regarding a particular entity (e.g., patient data, order data, provider data, or the like). The corresponding audit table 154 will store information cataloging the modifications over time to the records stored in the data table 152. Finally, the database 106 may store a global revision tracking table 156. While the specific contents of each data table 152 and audit table 154, and of the global revision tracking table 156 are discussed in connection with FIGS. 2A and 2B below, FIG. 1B illustrates that the contents of each audit table 154 are gathered from the corresponding data table 152 and from the global revision tracking table 156.

Turning now to FIGS. 2A through 2C, the relationships between a data table 202, audit table 204, and a global revision tracking table 206 are illustrated. FIG. 2A illustrates an example data table 202, in accordance with some example embodiments described herein. As noted above, each data table may store information regarding a particular entity (e.g., patient data, order data, provider data, or the like). Example data table 202, for instance, stores information regarding various regimens prescribed by a doctor for a patient. As shown by bracket 208, data table 202 in this example stores records having at least a record identifier field, although it will be appreciated that it may also include any number of additional fields to accommodate other attributes that are pertinent to the subject being cataloged by the data table. Further, while data table 202 is shown having two records 210 and 212 for ease of illustration, additional records may or may not be included therein.

Turning next to FIG. 2B, an example audit table 204 is shown that corresponds to data table 202. As shown in FIG. 2B, each record in the audit table 204 includes all of the fields of the data table itself (i.e., those fields represented by bracket 208), and in addition includes two additional fields, which represent the global revision number and the revision type, respectively, of each corresponding record in data table 202 (in this case, records 210 and 212 are shown, but again, this is for clarity of illustration and additional records may or may not also be included in various embodiments). It should be appreciated that the global revision number field can be populated by the OLTP system 102 from a global revision tracking table 206 when the OLTP system 102 modifies the data table 202, and that this may occur as one aspect of the procedure that propagates changes prompted by a particular transaction. As will be discussed in greater detail below, fields in the global revision number column 214 represent the system-wide unique reference number for the individual transaction corresponding to each record. Each field in the revision type column 216 illustrates whether the corresponding record is newly added, modified from a previous version, or deleted.

FIG. 2C illustrates an example global revision tracking table 206, in accordance with some example embodiments described herein. Each record in global revision tracking table 206 includes at least two fields. First, as noted above, the field in the global revision number column 214 represents a system-wide unique reference number for the individual transaction corresponding to each record. And the field in the transaction column 218 represents the transaction associated with that particular global revision number. As can be seen in example global revision tracking table 206, transactions 220 and 222 correspond to records 210 and 212 that are shown in the data table 202 and audit table 204.

Turning next to FIG. 2D, another example data table 224 is shown, in accordance with some example embodiments described herein. Example data table 224 may, for instance, stores information regarding various orders prescribed by a doctor for a patient undergoing a particular course of treatment. In contrast to data table 202, which included only a single record associated with each global revision number, data table 224 in this example stores four records, all of which were generated as part of the transaction corresponding to the entry of the first regimen in data table 202. As illustrated in data audit table 2 in FIG. 2E (item 226), because all of the records in data table 224 were prompted by this single transaction, the OLTP system 102 populates the global revision number field with the revision number corresponding to that transaction (Revision #221). Thus, as in the example discussed previously, if an OLTP system 102 receives entry of a single transaction from a user, various data tables can be affected, but their corresponding audit tables will be updated by the OLTP system 102 to correlate the various table modifications to the global revision number associated with the transaction from the user.

### System Architecture

Methods, apparatuses, and computer program products of the present invention may be embodied by any of a variety of devices. Example embodiments may include a plurality of devices operating in a globally-networked OLTP system. In doing so, example embodiments may utilize any of a variety of fixed terminals, such as desktop computers, mainframe devices, kiosks, or the like. Similarly, example embodiments may also utilize any of a variety of mobile terminals, such as portable digital assistants (PDAs), mobile telephones, smartphones, laptop computers, tablet computers, or any combination of the aforementioned devices.

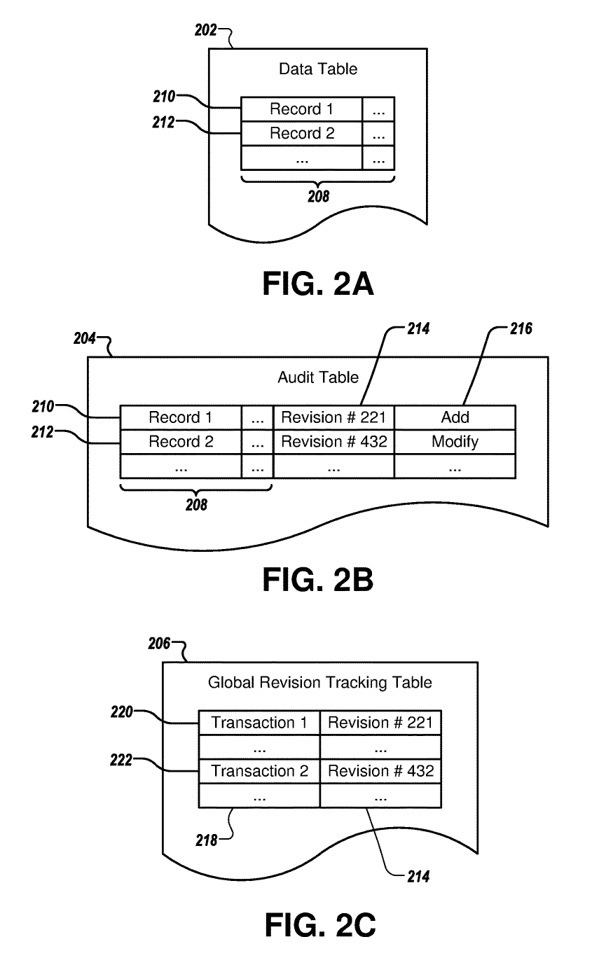

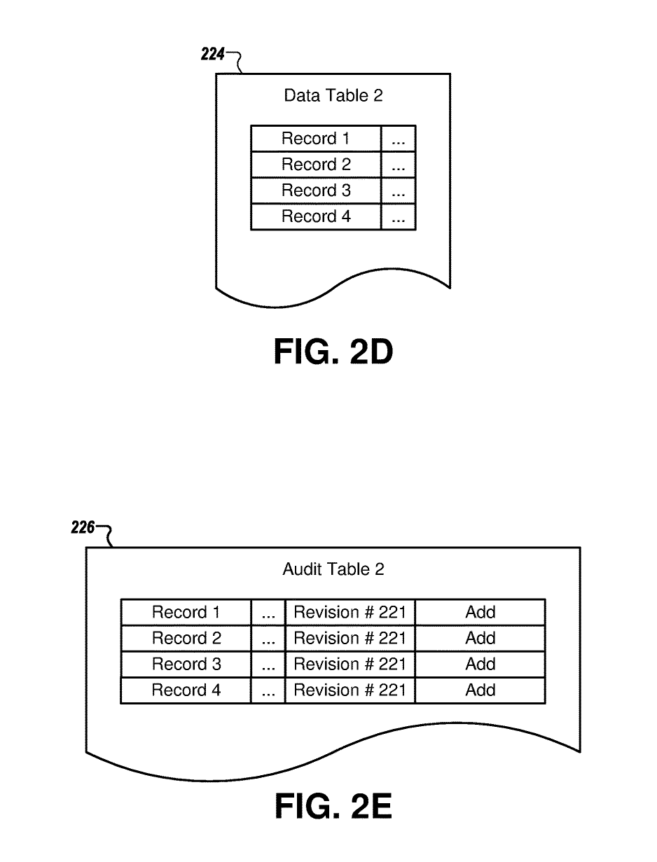

Turning to FIG. 3, an apparatus 300 is illustrated that represents a basic set of components of an example device configured to update various data within an example OLTP system. The apparatus 300 may include a processor 302, a memory 304, and communications circuitry 306. In some embodiments, the device may further include input/output circuitry 308 for interacting with a user, revisioning circuitry 310 for assigning global revision numbers to change data instructions, data modeling circuitry 312 for updating records based on change data instructions, and data auditing circuitry 314 for updating audit tables corresponding to updated data tables and based on change data instructions. The apparatus 300 may be configured to execute the operations described below in connection with FIGS. 4-7. Although these components 302-314 are described with some functional descriptors, it should be understood that the particular implementations necessarily include the use of particular hardware. It should also be understood that certain of these components 302-314 may include similar or common hardware. For example, the revisioning circuitry 310, data modeling circuitry 312, and data auditing circuitry 314 may leverage use of the processor 302, memory 304, or communications circuitry 306, to perform their associated functions, and duplicate hardware is not required for the distinct components of the apparatus 300 (although embodiments using duplicated hardware are also contemplated herein). The use of the term “circuitry” as used herein with respect to components of the apparatus therefore includes particular hardware configured to perform the functions associated with the particular circuitry described herein. Of course, while the term “circuitry” should be understood broadly to include hardware, in some embodiments, circuitry may also include software for configuring the hardware components of the apparatus 300.

In some embodiments, the processor 302 (and/or co-processor or any other processing circuitry assisting or otherwise associated with the processor) may be in communication with the memory 304 via a bus for passing information among components of the apparatus. The processor 302 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 302 may be configured to execute instructions stored in the memory 304 or otherwise accessible to the processor. Alternatively or additionally, the processor may be configured to execute hard-coded functionality. As such, whether configured by hardware or software methods, or by a combination of hardware with software, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the memory 304 may be non-transitory and may include, for example, one or more volatile and/or non-volatile memories. In other words, for example, the memory may be an electronic storage device (e.g., a computer readable storage medium). The memory 304 may be configured to store information, data, content, applications, instructions, or the like, for enabling the apparatus to carry out various functions in accordance with example embodiments contemplated herein.

The communications circuitry 306 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 306 may include, for example, a network interface for enabling communications with a wired or wireless communication network. For example, the communications circuitry 306 may include one or more network interface cards, antennae, buses, switches, routers, modems, and supporting hardware and/or software, or any other device suitable for enabling communications via a network. Additionally or alternatively, the communication interface 306 may include the circuitry for interacting with the antenna(s) to cause transmission of signals via the antenna(s) or to handle receipt of signals received via the antenna(s). These signals may be transmitted by the apparatus 300 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

In some embodiments, the apparatus 300 may include input/output circuitry 308 that may, in turn, be in communication with processor 302 to provide output to a user and, in some embodiments, to receive an indication of user input. The input/output circuitry 308 may comprise a user interface and may include a display that may include a web user interface, a mobile application, a client device, or the like. In some embodiments, the input/output circuitry 308 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

In addition, the apparatus 300 may also comprise revisioning circuitry 310, which includes hardware components designed for assigning global revision numbers to change data instructions. Revisioning circuitry 310 may utilize processor 302, memory 304, or any other hardware component included in the apparatus 300 to perform this function. Revisioning circuitry 310 may further utilize communications circuitry 306 to interact with other components in the OLTP system, such as for retrieval of the change data instructions forming the basis of each version generation operation and/or storage of a new global revision number in a global revision tracking table. Furthermore, revisioning circuitry 310 may additionally or alternatively use input/output circuitry 308 for retrieval of the change data instructions from a user.

In addition, the apparatus 300 may also comprise data modeling circuitry 312, which includes hardware components designed to update data tables based on change data instructions. Data modeling circuitry 312 may utilize processor 302, memory 304, or any other hardware component included in the apparatus 300 to perform these functions. Data modeling circuitry 312 may further utilize communications circuitry 306 to interact with other components in the OLTP system, such as for the storage of updated information in data tables in data stores located externally to the apparatus 300 itself but within the broader OLTP system.

In addition, the apparatus 300 may also comprise data auditing circuitry 314, which includes hardware components designed to update audit tables corresponding to updated data tables and based on change data instructions. Data auditing circuitry 314 may utilize processor 302, memory 304, or any other hardware component included in the apparatus 300 to perform this function. Data auditing circuitry 314 may further utilize communications circuitry 306 to interact with other components in the OLTP system, such as for the storage of records in audit tables in data stores located externally to the apparatus 300 itself but within the broader OLTP system.

Revisioning circuitry 310, data modeling circuitry 312, and data auditing circuitry 314 may utilize processing circuitry, such as the processor 302, to facilitate performance of their various operations, and may utilize memory 304 to store state computer instructions that, when executed, cause the revisioning circuitry 310, data modeling circuitry 312, or data auditing circuitry 314 to perform those operations. It should be appreciated that, in some embodiments, revisioning circuitry 310, data modeling circuitry 312, and/or data auditing circuitry 314 may include a separate processor, specially configured field programmable gate array (FPGA), or application specific interface circuit (ASIC) to perform the above-described functions. Revisioning circuitry 310, data modeling circuitry 312, and data auditing circuitry 314 may therefore implemented using hardware components of the apparatus configured by either hardware or software for implementing these planned functions.

As described above and as will be appreciated based on this disclosure, example embodiments may be implemented by a plurality of devices, such as fixed devices, mobile devices, backend network devices, and/or the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

It should be appreciated, with respect to certain devices embodied by apparatus 300 as described in FIG. 3, computer program instructions and/or other type of code may be loaded onto a computer, processor or other programmable apparatus's circuitry to produce a machine, such that the computer, processor other programmable circuitry that execute the code on the machine create the means for implementing various functions described herein.

Having described specific components of an example device (e.g., apparatus 300) that may be utilized to implement some embodiments of the present invention, example embodiments of the present invention are described below in connection with a series of flowcharts.

### Operations for Improving Scalability and Efficiency of an OLTP System

Turning to FIGS. 4-7, flowcharts are illustrated that contain operations improving scalability and efficiency of an OLTP system. The operations illustrated in FIGS. 4-7 may, for example, be performed by, with the assistance of, and/or under the control of an apparatus 300 embodying a device operatively controlling a database modeling platform 200 and more particularly through the use of one or more of processor 302, memory 304, communications circuitry 306, input/output circuitry 308, revisioning circuitry 310, data modeling circuitry 312, and data auditing circuitry 314.

Turning first to FIG. 4, example operations are provided for improving scalability and efficiency of an OLTP system.

In operation 402 the apparatus 300 includes means, such as processor 302, memory 304, communications circuitry 306, input/output circuitry 308, or the like, for receiving a change data instruction to edit one or more data tables stored by the OLTP system. In some embodiments, this change data instruction is received from a Java 2 Platform, Enterprise Edition (J2EE) application that initiates example embodiments via a Java database connectivity (JDBC) driver. Alternatively, this change data instruction may be received from a data warehouse extract, transform, and load (ETL) process (e.g., during initial staging of a new data source or during an update in which new records are received from an existing data source).

In operation 404 the apparatus 300 includes means, such as revisioning circuitry 310 or the like, for assigning a global revision number to the change data instruction in response to receiving the change data instruction. In this regard, the global revision number is unique within the OLTP system. In some embodiments, assigning the global revision number to the revision includes generating the global revision number, and storing the global revision number in a global revision tracking table.

In operation 406 the apparatus 300 includes means, such as data modeling circuitry 312 or the like, for updating, by data modeling circuitry, one or more records in the one or more data tables stored by the OLTP system based on the change data instruction. For instance, the change data instruction may expressly identify a series of updates to be performed that may directly affect one or more records. As another example, upon determining that a first data table affected by the change data instruction is linked with a second data table, the data modeling circuitry 312 may be configured to propagate changes from the first data table to the second data table.

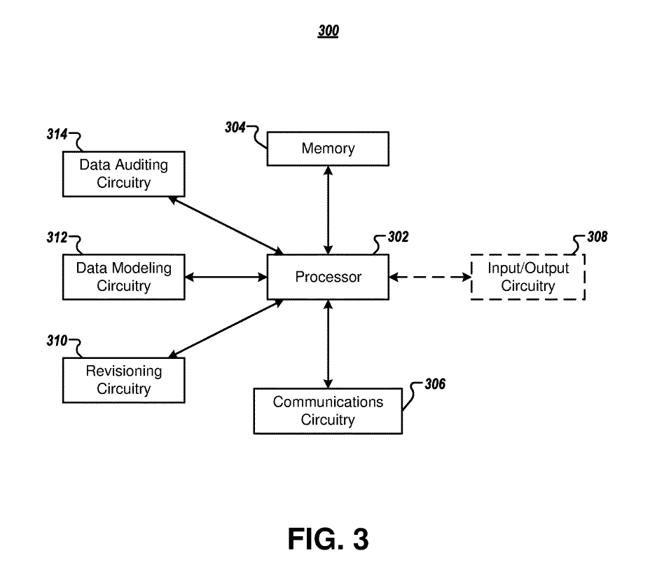

In operation 408 the apparatus 300 includes means, such as data auditing circuitry 314 or the like, for inserting one or more audit records corresponding to the one or more updated records into one or more audit tables corresponding to the one or more data tables. It will be understood that in some embodiments, each audit record includes a revision number field identifying the global revision number and a revision type field indicating whether a corresponding updated record of the one or more updated records is newly added, modified from a previous version, or deleted. In some embodiments, inserting the one or more audit records corresponding to the one or more updated records into the one or more audit tables corresponding to the one or more tables may itself comprise two sub-steps, described in connection with FIG. 5 below.

Turning next to FIG. 5, example operations are described for inserting one or more audit records corresponding to the one or more updated records into one or more audit tables corresponding to the one or more data tables, in accordance with example embodiments described herein.

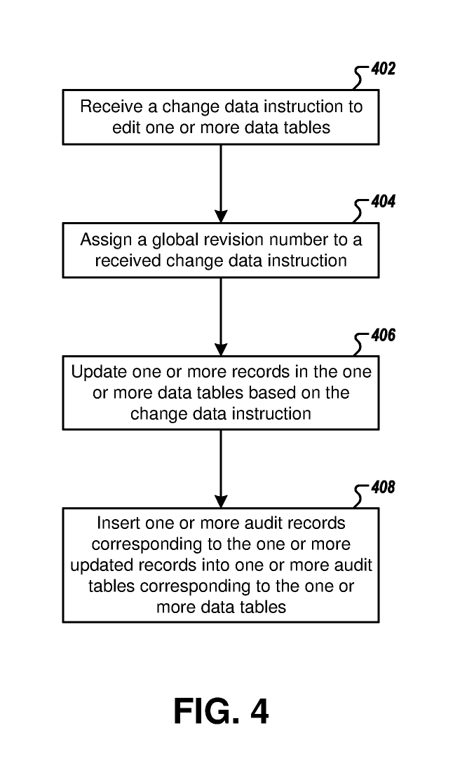

In operation 502 the apparatus 300 includes means, such as data auditing circuitry 314 or the like, for generating insert statements for the one or more audit tables. In some example embodiments utilizing an Oracle database, the generation of insert statements may utilize Procedural Language/Structured Query Language (PL/SQL) packages that consist of flowing parts. Embodiments that are purely PL/SQL in nature are more flexible and embeddable in any Oracle database-backed J2EE application. Thus, such example embodiments can easily be utilized in a variety of systems. The generation of insert statements may include the sub-steps described below in connection with FIG. 6.

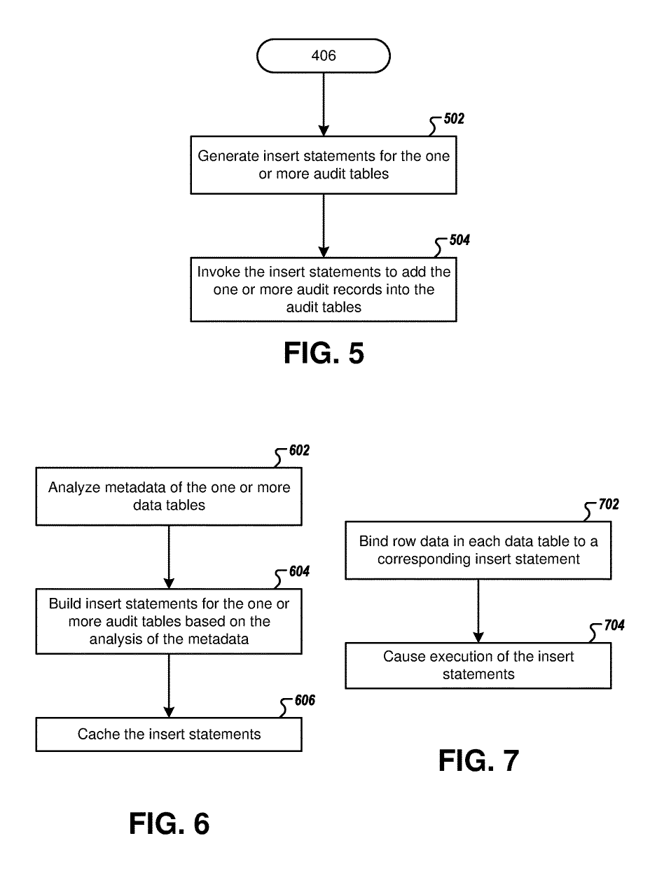

In operation 504 the apparatus 300 includes means, such as data auditing circuitry 314 or the like, for invoking the insert statements generated for each audit table to add a subset of the one or more audit records into the audit table that correspond to a subset of the updated records that are stored in a corresponding data table. It should be understood that invocation of insert statements corresponding to audit tables may occur in a linear process. However, some example embodiments may invoke insert statements corresponding to multiple audit tables in a batch process, such as in situations where the processing time required to invoke the insert statements may slow down the OLTP system or otherwise create a bottleneck if performed in a linear fashion. In either case, invocation of the insert statements may include the sub-steps described below in connection with FIG. 7.

Turning next to FIG. 6, example operations are described for generating insert statements for one or more audit tables, in accordance with example embodiments described herein.

In operation 602 the apparatus 300 includes means, such as data auditing circuitry 314 or the like, for analyzing metadata of the one or more data tables. As part of this analysis, the data auditing circuitry 314 may, in some embodiments, read column metadata for the one or more data tables and determine differences between them (e.g., in an embodiment utilizing an Oracle database, this may include evaluating “diff columns” using database metadata tables).

In operation 604 the apparatus 300 includes means, such as data auditing circuitry 314 or the like, for building insert statements for the one or more audit tables based on the metadata of each corresponding data table.

In operation 606 the apparatus 300 includes means, such as data auditing circuitry 314 or the like, for caching the insert statements. In this regard, because statement generation is an expensive operation, caching these insert statements avoids the need to repeat the generation of insert statements, thus reducing the total computational burden required to implement example embodiments described herein.

Turning next to FIG. 7, example operations are disclosed for invoking insert statements generated for one or more audit tables, in accordance with some example embodiments described herein.

In operation 702 the apparatus 300 includes means, such as data auditing circuitry 314 or the like, for binding, to the insert statement generated for each audit table, row data in the corresponding data table that describes the subset of the updated records that are stored in that particular data table. Binding all of the row data for each data table to the insert statement for the corresponding audit table thus ensures that execution of a single insert statement will add all of the appropriate records to the corresponding audit table. Moreover, by binding actual row data to the generated insert statement, example embodiments enable single or batch-based data manipulation language (DML) execution.

Finally, in operation 704 the apparatus 300 includes means, such as data auditing circuitry 314 or the like, for causing execution of one insert statement for each of the various audit tables. Accordingly, in contrast to traditional systems in which a new SQL insert statement is necessary to insert each record into the audit table, example embodiments utilizing the operations described herein can thereby eliminate a significant percentage of the SQL statements that have historically been required to populate an audit table.

As described above, example methods and apparatuses disclosed herein can improve the scalability and efficiency of database management systems. To do this, example embodiments utilize enterprise-level revision numbering to readily identify changes associated with a given revision, and utilize pre-generated and cached insert statements to greatly reduce the number of SQL statements required to commit such changes to the data tables and corresponding audit tables in an OLTP system. Because the use of enterprise-level revision numbering facilitates queries for all changes associated with a given revision in addition to querying for changes for a given row across multiple revisions, the architecture described herein leads to very expressive SQL-based querying for generation of audit reports. Some example embodiments may be implemented using purely PL/SQL, thus making such embodiments easily embeddable in any Oracle database-backed J2EE application.

FIGS. 4-7 illustrate flowcharts describing the operation of apparatuses, methods, and computer program products according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory of an apparatus 300 employing an embodiment of the present invention and executed by a processor of the apparatus 300. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware and computer instructions.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for improving scalability and efficiency of an online transaction processing (OLTP) system, the method comprising:
assigning, by revisioning circuitry and in response to receiving a change data instruction to edit one or more data tables stored by the OLTP system, a global revision number to the change data instruction, wherein the global revision number is unique within the OLTP system;
updating, by data modeling circuitry, one or more records in the one or more data tables stored by the OLTP system based on the change data instruction; and
inserting, by data auditing circuitry, one or more audit records corresponding to the one or more updated records into one or more audit tables corresponding to the one or more data tables,
wherein each audit record includes a revision number field identifying the global revision number and a revision type field indicating whether a corresponding updated record of the one or more updated records is newly added, modified from a previous version, or deleted.

2. The method of claim 1, wherein assigning the global revision number to the revision includes:
generating the global revision number; and
storing the global revision number in a global revision tracking table.

3. The method of claim 1, wherein inserting the one or more audit records corresponding to the one or more updated records into the one or more audit tables corresponding to the one or more tables includes:
generating insert statements for the one or more audit tables; and
for each particular audit table corresponding to a particular data table of the one or more data tables,
invoking the insert statement generated for the particular audit table to add a subset of the one or more audit records into the particular audit table that correspond to a subset of the updated records that are stored in the particular data table.

4. The method of claim 3, wherein generating the insert statements includes:
analyzing metadata of the one or more data tables;
building insert statements for the one or more audit tables based on the metadata of each corresponding data table; and
caching the insert statements.

5. The method of claim 3, wherein invoking the insert statement generated for a particular audit table includes:
binding, to the insert statement generated for the particular audit table, row data in the particular data table that describes the subset of the updated records that are stored in the particular data table; and
causing execution of the insert statement generated for the particular audit table.

6. The method of claim 3, wherein inserting the one or more audit records into the one or more audit tables includes invoking insert statements corresponding to multiple audit tables in a batch process.

7. The method of claim 1, wherein the change data instruction is received from:
a Java 2 Platform, Enterprise Edition (J2EE) application using a Java database connectivity (JDBC) driver; or
a data warehouse extract, transform, and load (ETL) process.

8. An apparatus for improving scalability and efficiency of an online transaction processing (OLTP) system, the apparatus comprising at least one processor and at least one memory storing computer-executable instructions, that, when executed by the at least one processor, cause the apparatus to:
assign, in response to receiving a change data instruction to edit one or more data tables stored by the OLTP system, a global revision number to the change data instruction, wherein the global revision number is unique within the OLTP system;
update, one or more records in the one or more data tables stored by the OLTP system based on the change data instruction; and
insert one or more audit records corresponding to the one or more updated records into one or more audit tables corresponding to the one or more data tables,
wherein each audit record includes a revision number field identifying the global revision number and a revision type field indicating whether a corresponding updated record of the one or more updated records is newly added, modified from a previous version, or deleted.

9. The apparatus of claim 8, wherein the computer-executable instructions, when executed by the at least one processor, cause the apparatus to assign the global revision number to the revision by causing the apparatus to:
generate the global revision number; and
store the global revision number in a global revision tracking table.

10. The apparatus of claim 8, wherein the computer-executable instructions, when executed by the at least one processor, cause the apparatus to insert the one or more audit records corresponding to the one or more updated records into the one or more audit tables corresponding to the one or more tables by causing the apparatus to:
generate insert statements for the one or more audit tables; and
for each particular audit table corresponding to a particular data table of the one or more data tables,
invoke the insert statement generated for the particular audit table to add a subset of the one or more audit records into the particular audit table that correspond to a subset of the updated records that are stored in the particular data table.

11. The apparatus of claim 10, wherein the computer-executable instructions, when executed by the at least one processor, cause the apparatus to generate the insert statements by causing the apparatus to:
analyze metadata of the one or more data tables;
build insert statements for the one or more audit tables based on the metadata of each corresponding data table; and
cache the insert statements.

12. The apparatus of claim 10, wherein the computer-executable instructions, when executed by the at least one processor, cause the apparatus to invoke the insert statement generated for a particular audit table by causing the apparatus to:
bind, to the insert statement generated for the particular audit table, row data in the particular data table that describes the subset of the updated records that are stored in the particular data table; and
cause execution of the insert statement generated for the particular audit table.

13. The apparatus of claim 10, wherein the computer-executable instructions, when executed by the at least one processor, cause the apparatus to insert the one or more audit records into the one or more audit tables by causing the apparatus to invoke insert statements corresponding to multiple audit tables in a batch process.

14. The apparatus of claim 8, wherein the computer-executable instructions, when executed by the at least one processor, cause the apparatus to receive the change data instruction from:
a Java 2 Platform, Enterprise Edition (J2EE) application using a Java database connectivity (JDBC) driver; or
a data warehouse extract, transform, and load (ETL) process.

15. A computer program product comprising at least one non-transitory computer-readable storage medium for improving scalability and efficiency of an online transaction processing (OLTP) system, the at least one non-transitory computer-readable storage medium storing computer-executable instructions that, when executed, cause an apparatus to:
assign, in response to receiving a change data instruction to edit one or more data tables stored by the OLTP system, a global revision number to the change data instruction, wherein the global revision number is unique within the OLTP system;
update one or more records in the one or more data tables stored by the OLTP system based on the change data instruction; and
insert one or more audit records corresponding to the one or more updated records into one or more audit tables corresponding to the one or more data tables,
wherein each audit record includes a revision number field identifying the global revision number and a revision type field indicating whether a corresponding updated record of the one or more updated records is newly added, modified from a previous version, or deleted.

16. The computer program product of claim 15, wherein the computer-executable instructions, when executed, cause the apparatus to assign the global revision number to the revision by causing the apparatus to:
generate the global revision number; and
store the global revision number in a global revision tracking table.

17. The computer program product of claim 15, wherein the computer-executable instructions, when executed, cause the apparatus to insert the one or more audit records corresponding to the one or more updated records into the one or more audit tables corresponding to the one or more tables by causing the apparatus to:
generate insert statements for the one or more audit tables; and
for each particular audit table corresponding to a particular data table of the one or more data tables,
invoke the insert statement generated for the particular audit table to add a subset of the one or more audit records into the particular audit table that correspond to a subset of the updated records that are stored in the particular data table.

18. The computer program product of claim 17, wherein the computer-executable instructions, when executed, cause the apparatus to generate the insert statements by causing the apparatus to:
analyze metadata of the one or more data tables;
build insert statements for the one or more audit tables based on the metadata of each corresponding data table; and
cache the insert statements.

19. The computer program product of claim 17, wherein the computer-executable instructions, when executed, cause the apparatus to invoke the insert statement generated for a particular audit table by causing the apparatus to:
bind, to the insert statement generated for the particular audit table, row data in the particular data table that describes the subset of the updated records that are stored in the particular data table; and
cause execution of the insert statement generated for the particular audit table.

20. The computer program product of claim 17, wherein the computer-executable instructions, when executed, cause the apparatus to insert the one or more audit records into the one or more audit tables by causing the apparatus to invoke insert statements corresponding to multiple audit tables in a batch process.
